(19) United States
(12) Patent Application Publication
(10) Pub. No.: US 2006/0041069 A1
(43) Pub. Date: Feb. 23, 2006

(54) Sealing material for semiconductor device and method for production thereof

(75) Inventors: Naoko Sumi, Chiba (JP); Hiroki Kamiya, Chiba (JP); Masanori Okazaki, Nara (JP); Yukio Kobayashi, Nara (JP); Yoshitaka Samura, Nara (JP)

Correspondence Address: ROBERT J JACOBSON PA, 650 BRIMHALL STREET SOUTH, ST PAUL, MN, 551161511, US

(73) Assignees: Asahi Glass Co., LTD., Tokyo (JP); Nippon Valqua Industries, Ltd., Tokyo (JP)

(21) Appl. No.: 10/528,476

(22) PCT Filed: Oct. 9, 2003
(86) PCT No.: PCT/JP03/12929

§ 371 Date: Mar. 19, 2005

(30) Foreign Application Priority Data
Oct. 11, 2002 (JP) 2002-299388
Oct. 11, 2002 (JP) 2002-299389

(51) Int. Cl. C08F 8/00

(52) U.S. Cl. 525/192; 525/326.2; 525/326.3

(57) ABSTRACT

The present invention provides: a first sealing material for semiconductor device which sealing material is excellent in plasma resistance and inexpensive; and a second sealing material for semiconductor device and a method of manufacturing this sealing material wherein the sealing material has a good surface smoothness and a good dimensional precision. The first sealing material contains a fluororubber as a rubber component wherein the fluororubber inevitably contains a cured product of a fluorine-based elastic copolymer of a specific composition. The second sealing material is obtained by crosslinking, with ionizing radiation, a fluororubber preform containing a fluororubber component (a) (comprising a specific fluorine-based elastic copolymer) and a non-elastic fluororesin component (b) (comprising a vinylidene fluoride (co)polymer) in a specific ratio.

### TECHNICAL FIELD

This invention relates to a sealing material for semiconductor device and a manufacturing method therefor.

### BACKGROUND ART

A semiconductor manufacturing process has included: a step of conducting a fine processing or a fine treatment on a work piece selectively using various kinds of plasma gases such as O₂, CF₄, O₂+CF₄, N₂, Ar, H₂, NF₃, CH₃F, CH₂F₂, CH₂F₆, Cl₂, BCl₃, TEOS and SF₆, and a plasma treatment has been conducted in a sealed treatment chamber in a semiconductor device in order to realize a plasma environment suitable for each of the plasma gases. An elastomer such as rubber has been usually used as a sealing material for the purpose to seal the treatment chamber itself, to seal an opening for use in taking-in or taking-out of a work piece provided in the treatment chamber and to seal a piping system.

Since a sealing material used in the above cases is affected directly or indirectly by plasma exposure, however, there has been a problem that degradation such as generation of particles from a sealing material and weight-loss of the sealing material occurs with ease, resulting in a great adverse influence on semiconductor manufacturing. That is, generation of particles decreases a product yield in semiconductor manufacturing and if weight-loss occurs, sealability is spoiled, making it difficult to maintain a treatment environment. In order to avoid such a problem, there has been desired for a sealing material made from a rubber material excellent in plasma resistance.

It has been conventionally known that a fluororubber is excellent in chemical resistance, weather resistance, heat resistance and the like and suitable for a sealing material for semiconductor device. A perfluorinated rubber has been known as the most excellent rubber material in terms of plasma resistance, whereas since the perfluorinated rubber is very expensive, poor in general versatility and insufficient in moldability to a sealing material such as an O ring, there has been a problem of limiting the scope of application thereof. Accordingly, there has been desired for an inexpensive sealing material, though, with a sufficient plasma resistance.

On the other hand, it has been encountered that a fluororubber does not necessarily show sufficient plasma resistance according to a kind of a plasma gas. To be concrete, though a fluororubber is effective in an etching step in which a plasma mainly of a fluorocarbon gas is employed, the fluororubber is hard to exert good resistance to a plasma of oxygen gas. Therefore, conventionally, a silicone rubber showing a resistance relatively better than a fluororubber was mainly used in an ashing step adopting oxygen gas and sealing materials were selectively employed in an etching step and an ashing step, respectively. Recently, since, in more cases, different treatments have been conducted in a single semiconductor device, in which fluorocabon gas and oxygen gas are used in the same treatment chamber, there has arisen a desire for a sealing material good in plasma resistance in environments of both gases.

In order to deal with the desires, developments on various kinds of sealing materials have been tried with inexpensive fluororubber as a base along a direction in which plasma resistance to oxygen gas is improved. Many techniques for the purpose have been reported, which are as follows: a technique in which silica having a plasma shielding effect is mixed thereinto (for example, JP No.2858198); a technique in which a polyamine crosslinking agent is mixed into a fluororubber (for example, JP-A No. 2001-114964); a technique in which a polyamine crosslinking agent and a polyol crosslinking agent combined are mixed into a fluororubber (for example, JP-A No. 2001-164066); and a technique in which a crystalline resin is added into a fluororubber to thereby, obtain a sealing material excellent in oxygen plasma resistance and low in compression set (for example, JP-A No. 2002-161264).

Recently, however, in order to achieve various kinds of tasks in a semiconductor manufacturing process such as realization of a finer design rule applied on a semiconductor wafer and increase in throughput of semiconductor wafers, there have been increased cases where a plasma of a mixed gas composed of oxygen gas and a fluorocarbon gas is employed, which results in a plasma environment severer than that in conventional etching step and an ashing step, leading to the status quo in which no sufficient plasma resistance is exerted with a sealing material based on a conventional technique. That is, according to a technique described above, though in a case where oxygen gas or a fluorocarbon gas is used alone in plasma, plasma resistance can be exerted, there has been arisen a problem of insufficient plasma resistance in a case where a plasma of a mixed gas composed of oxygen gas and a fluorocarbon gas is used.

In a technique described above, however, in which silica, an acid receiving agent necessary for polyamine crosslinking and the like are required to be mixed in, a possibility has been worried of a problem that the mixing of the additives newly causes generation of released impurities such as particles and gases from a sealing material.

Note that as has been described in the publications, in addition to plasma resistance, a compression set that is necessary to exert a sufficient sealing performance has also been regarded as a task to be achieved for a sealing material for use in a semiconductor device, whereas in the current state in which a plasma environment has been severer, which is described above, part of a work piece exposed to a plasma is actually decomposed and vaporized, a mass of the sealing material decreases, a shape of the work piece alters in company of the weight-loss of the sealing material, with the result that a performance as a sealing material cannot be sustained due to alteration in shape before reduction in sealing performance is caused by a compression set. Therefore, plasma resistance is the most important factor determining a lifetime in service of a sealing material.

Generation of particles from a sealing material and weight-loss of the sealing material has been a problem, which is described above, in a case where fluororubber is adopted as a sealing material of a site exposed directly or indirectly to a plasma generated in a semiconductor device. A quantity of generated particles and weight-loss of a sealing material are greatly affected by additives commonly mixed thereinto in order to impart the fluororubber moldability such as a crosslinking agent and a filler. Hence, it is desired not to include the additives such as a crosslinking agent and a filler from the viewpoint of plasma resistance, having lead to a desire for development of a high purity sealing material.

There has been known a method in which a fluororubber is crosslinked by irradiation with ionizing radiation, as a method obtaining a sealing material made from a fluororubber without mixing a crosslinking agent and a filler thereinto (for example, JP-A No. 2002-167454). In such a method in which a fluororubber is crosslinked by irradiation with ionizing radiation, the fluororubber is preformed prior to crosslinking with an extruder or a press, and since thus obtained preform is poor in shape retaining property, dimensional stability and surface smoothness are apt to be insufficient, there has been a case of losing a dimensional precision and smoothness of a surface of a sealing material when the preform is to be matured into the sealing material. In addition, since a preform prior to crosslinking is easy to be subjected to plastic deformation, a molded shape cannot be retained to thereby, alter dimensional precision if the weight thereof or an external force is acted thereon between irradiation with ionizing radiation and preforming, which necessitates carefulness in handling the preform prior to crosslinking, leading to poor workability prior to an irradiation treatment with ionizing radiation with the result of a tendency that a dimensional precision of an obtained sealing material is insufficient.

### DISCLOSURE OF THE INVENTION

### OBJECTS OF THE INVENTION

It is accordingly an object of the invention to provide an inexpensive sealing material for semiconductor device, excellent in plasma resistance in various kinds of plasma environments.

It is another object of the invention to provide a sealing material for semiconductor device, having a good surface smoothness and a good dimensional precision without mixing an additive such as a crosslinking agent or a filler into the sealing material, and it is still another object of the invention to provide a manufacturing method capable of easily obtaining the sealing material with good workability.

### SUMMARY OF THE INVENTION

The inventor has conducted serious studies in order to solve the tasks. As a result, the inventor has found that it is effective for obtaining an inexpensive sealing material for semiconductor device excellent in plasma resistance to select, as a fluororubber, a vinylidene fluoride/hexafluoropropylene/tetrafluoroethylene elastic copolymer and to design a fluorine content therein to a value in a specific range higher than conventional. The inventor further has found that a non-elastic fluororesin comprising a vinylidene fluoride (co)polymer together with a specific fluorine-based elastic copolymer is uniformly incorporated into a preform prior to crosslinking by ionizing radiation in a specific ratio to thereby obtain an inexpensive sealing material for semiconductor device, having a good surface smoothness, a good dimensional precision and excellent in plasma resistance without mixing an additive such as a crosslinking agent or a filler into the sealing material, which has led to completion of the invention.

That is, a first sealing material for semiconductor device concerning the invention is a sealing material containing a fluororubber as a rubber component and is characterized in that: the fluororubber inevitably contains a cured product of a vinylidene fluoride/hexafluoropropylene/tetrafluoroethylene elastic copolymer; and copolymerization ratios of monomers in the vinylidene fluoride/hexafluoropropylene/ tetrafluoroethylene elastic copolymer are such that: a content of vinylidene fluoride is in the range of from 25 to 70 mol %; a content of hexafluoropropylene is in the range of from 15 to 60 mol %; a content of tetrafluoroethylene is in the range of from 15 to 60 mol %; and a fluorine content in the vinylidene fluoride/hexafluoropropylene/tetrafluoroethylene elastic copolymer is in the range of from 71.5 to 75 mass %.

A second sealing material for semiconductor device concerning the invention is characterized by being obtained by crosslinking, with ionizing radiation, a fluororubber preform containing a fluororubber component (a) comprising a vinylidene fluoride/hexafluoropropylene elastic copolymer and/or a vinylidene fluoride/hexafluoropropylene/tetrafluoroethylene elastic copolymer and a non-elastic fluororesin component (b) comprising a vinylidene fluoride (co)polymer in composition of the fluororesin component (b) of 1 to 50 parts by mass relative to 100 parts by mass of the fluororubber component (a).

A manufacturing method for a sealing material for semiconductor device concerning the invention is a manufacturing method in which 100 parts by mass of a fluororubber component (a) comprising a vinylidene fluoride/hexafluoropropylene elastic copolymer and/or a vinylidene fluoride/hexafluoropropylene/tetrafluoroethylene elastic copolymer and 1 to 50 parts by mass of a non-elastic fluororesin component (b) comprising a vinylidene fluoride (co)polymer are mixed at a temperature of a melting point of the fluororesin component (b) or higher, thereafter the mixture is preformed, and the obtained preform is irradiated with ionizing radiation.

### DETAILED DESCRIPTION OF THE INVENTION

While detailed description will be given of a first sealing material for semiconductor device and a second sealing material for semiconductor device, and a manufacturing method for the second sealing material for semiconductor device, all being related to the invention below, it should be understood that the invention is not limited by the detailed description and modifications and variations of the following examples can be properly made without departing from the spirit and scope of the invention.

At first, description is given of the first sealing material for semiconductor device concerning the invention, subsequent to which description is given of a second sealing material for semiconductor device concerning the invention, and a manufacturing method for the second sealing material.

<First Sealing Material for Semiconductor Device>

The first sealing material for semiconductor device of the invention is a sealing material containing a fluororubber as a rubber component inevitably comprising a cured product of a vinylidene fluoride/hexafluoropropylene/tetrafluoroethylene elastic copolymer.

In the first sealing material for semiconductor device, it is important that copolymerization ratios of respective monomers in the vinylidene fluoride/hexafluoropropylene/tetrafluoroethylene elastic copolymer are such that a content of vinylidene fluoride is in the range of from 25 to 70 mol %; a content of hexafluoropropylene is in the range of from 15 to 60 mol %; and a content of tetrafluoroethylene is in the range of from 15 to 60 mol %. A copolymerization ratio of vinylidene fluoride is preferably in the range of from 25 to 60 mol % and more preferably in the range of from 25 to 50 mol %; a copolymerization ratio of hexafluoropropylene is preferably in the range of from 20 to 55 mol % and more preferably in the range of from 20 to 50 mol %; and a copolymerization ratio of tetrafluoroethylene is preferably in the range of from 20 to 55 mol % and more preferably in the range of from 25 to 50 mol %. With copolymerization ratios of the respective monomers in the vinylidene fluoride/hexafluoropropylene/tetrafluoroethylene elastic copolymer in the ranges adopted, a fluorine content can be set in the range described later and an obtained sealing material has not only a sufficient rubber elasticity, but also excellent plasma resistance to various kinds of gases. Since a vinylidene fluoride/hexafluoropropylene/tetrafluoroethylene elastic copolymer is not expensive as compared with a perfluorinated rubber, which is expensive, the obtained sealing material is inexpensive and applications thereof are rich in general versatility.

In the first sealing material for semiconductor device, it is important that a fluorine content in vinylidene fluoride/hexafluoropropylene/tetrafluoroethylene elastic copolymer is in the range of from 71.5 to 75 mass %. A fluorine content in the elastic copolymer is preferably in the range of from 72 to 74.5 mass % and more preferably in the range of from 72.5 to 74 mass %. If a fluorine content in the elastic copolymer is lower than the range, a sealing material cannot exert sufficient plasma resistance to various gases. On the other hand, if a fluorine content in the elastic copolymer exceeds the range, an obtained sealing material loses rubber elasticity and compression set and flexibility at a low temperature are degraded, thereby disabling a sufficient sealing performance to be ensured. A copolymer having a fluorine content exceeding the range is substantially not easy to be manufactured. Note that a fluorine content can be measured in a procedure in which a copolymer is burned to free fluorine as fluorine ions and to trap the fluorine ions, followed by quantification of a fluorine ion concentration with an ion concentration meter and the measurement has only to follow a method described in NIPPON KAGAKU KAISHI, 1973, p 1236 to 1237, for example.

The vinylidene fluoride/hexafluoropropylene/tetrafluoroethylene elastic copolymer may be obtained by additionally copolymerizing other monomers than vinylidene fluoride, hexafluoropropylene and tetrafluoroethylene with the elastic copolymer. Examples of the other monomers include: fluorinated olefins such as chlorotrifluoroethylene, vinyl fluoride and pentafluoropropylene; perfluoro(alkyl vinyl ether)s such as perfluoro(methyl vinyl ether), perfluoro(propyl vinyl ether), perfluoro(3,6-dioxa-5-methyl-1-decene); and others. In a case where a monomer other than vinylidene fluoride, hexafluoropropylene and tetrafluoroethylene is additionally copolymerized, a copolymerization ratio of the monomer is preferably 30 mol % or less and more preferably 15 mol % or less relative to a total of copolymerization ratios of vinylidene fluoride, hexafluoropropylene and tetrafluoroethylene, respectively.

The vinylidene fluoride/hexafluoropropylene/tetrafluoroethylene elastic copolymer may have a bromine atom, iodine atom or a double bond as a curing site in a molecule, and especially in a case where the copolymer is cured into a cured product by curing with an organic peroxide as described later, it is indispensable to have a bromine atom, an iodine atom or a double bond as a curing site. A bromine atom, an iodine atom or a double bond can be introduced into an obtained elastic copolymer or a fluororubber by adding a small quantity of a chain transfer agent or a curing site monomer having a bromine atom, an iodine atom or a double bond or by applying an after-treatment such as a heat treatment or an alkaline treatment to the obtained elastic copolymer or the fluororubber in manufacturing the vinylidene fluoride/hexafluoropropylene/tetrafluoroethylene elastic copolymer by polymerization of each of the monomers. Examples of the chain transfer agents, to be concrete, include: perfluoro( 1,4-diiodobutane), perfluoro(1-bromo-4-iodobutane), perfluoro(1,6-diiodohexane), perfluoro(1,8-diiodooctane) and others. Examples of the curing site monomers, to be concrete, include: perfluoro(3-iodo-1-propene), perfluoro(4-iodo-1-butene), perfluoro(4-bromo-1-butene), perfluoro(5-bromo-3-oxa-1-pentene), perfluoro(6-iodo-1-hexene) and others. Note that no specific limitation is placed on a quantity of a bromine atom, a iodine atom or a double bond introduced thereinto and for example, it is preferable that a content of bromine atoms in a vinylidene fluoride/hexafluoropropylene/tetrafluoroethylene elastic copolymer is in the range of from 0.05 to 1.5 mass %, a content of iodine atoms is in the range of from 0.01 to 5 mass % and a content of double bonds is in the range of from 0.001 to 3 mol %.

No specific limitation is placed on a polymerization method to obtain the vinylidene fluoride/hexafluoropropylene/tetrafluoroethylene elastic copolymer and there can be adopted known methods such as bulk polymerization, suspension polymerization, emulsion polymerization, solution polymerization and others, among which preferable are emulsion polymerization and suspension polymerization. Examples of the polymerization initiating reactions include: a radical polymerization method using an organic peroxide initiator, an azo initiator or the like; a redox polymerization method using a redox catalyst; a radiation polymerization method using ionizing radiation; a polymerization using heat or light and others, among which preferable are a radical polymerization method and a redox polymerization method.

No specific limitation is imposed on a molecular weight of a vinylidene fluoride/hexafluoropropylene/tetrafluoroethylene elastic copolymer and a molecular weight thereof is preferably in the range of from 2,000 to 500,000 from the viewpoint of a physical property and moldability.

No specific limitation is imposed on a glass transition temperature of a vinylidene fluoride/hexafluoropropylene/tetrafluoroethylene elastic copolymer and a glass transition temperature thereof is preferably 10° C. or lower. If a glass transition temperature thereof exceeds 10° C., a tendency arises that flexibility at a low temperature is poorer and sealability decreases.

No specific limitation is placed on a curing method in transforming a vinylidene fluoride/hexafluoropropylene/tetrafluoroethylene elastic copolymer into a cured product and examples thereof include: conventional known methods such as an organic peroxide curing method, a polyol curing method and a polyamine curing method. Note that conditions for curing in this case have only to be properly set so as to be adapted for operating conditions and others, and the conditions are preferably, for example, such that a time is in the range of about several seconds to 24 hours and a temperature is in the range of from 100 to 400° C.

The curing with a organic peroxide is preferably conducted in a curing system in which an organic peroxide is used as a curing agent and an unsaturated polyfunctional compound is used as a curing co-agent. Examples of the organic peroxides include: benzoyl peroxide, dichlorobenzoyl peroxide, dicumyl peroxide, 2,5-dimethyl-2,5-di(peroxybenzoate)hexine-3,1,4-bis(tert-butylperoxyisopropyl)benzene, lauroyl peroxide, tert-butyl peracetate, 2,5-dimethyl-2,5-di(tert-butylperoxy)hexine-3,2,5-dimethyl-2,5 -di(tert-butylperoxy)hexane, tert-butyl perbenzoate, tert-butylperphenyl acetate, and others. Examples of the unsaturated polyfunctional compounds to be used include: trially isocyanurate, trially cyanurate, trimethylolpropane trimethacrylate, polybutadiene and others. A use amount of an organic peroxide is preferably in the range of from 0.1 to 3 parts by mass relative to 100 parts by mass of a vinylidene fluoride/hexafluoropropylene/tetrafluoroethylene elastic copolymer, and a use amount of an unsaturated polyfunctional compound is preferably in the range of from 0.5 to 10 parts by mass relative to 100 parts by mass of a vinylidene fluoride/ hexafluoropropylene/tetrafluoroethylene elastic copolymer.

The curing with a polyol is preferably conducted in a curing system in which a polyhydroxy compound as a curing agent is used together with a curing accelerator and an acid receiving agent. Examples of the polyhydroxy compounds that can be preferably used include: aromatic polyhydroxy compounds such as bisphenol AF, bisphenol A and hydroquinone. Examples of the curing accelerators that can be preferably used include: quaternary phosphonium salts such as triphenylbenzyl phosphonium chloride and trioctylmethyl phosphonium chloride; quaternary ammonium salts such as tetrabutyl ammonium bromide, tetrabutyl ammonium hydrogen sulfate and 8-benzyl-1,8-diazabicyclo[5.4.0]-7-undecenium chloride; and organic onium compounds such as iminium salt and sulfonium salt. As the acid receiving agents, there can be preferably used, for example, oxides or hydroxides of divalent metals such as magnesium, calcium, zinc, lead and others. Note that a use amount of a polyhydroxy compound is preferably in the range of from 0.3 to 5 parts by mass relative to 100 parts by mass of a vinylidene fluoride/hexafluoropropylene/tetrafluoroethylene elastic copolymer, a use amount of a curing accelerator is preferably in the range of from 0.01 to 5 parts by mass relative to 100 parts by mass of a vinylidene fluoride/hexafluoropropylene/tetrafluoroethylene elastic copolymer and a use amount of an acid receiving agent is preferably in the range of from 1 to 15 parts by mass relative to 100 parts by mass of a vinylidene fluoride/hexafluoropropylene/tetrafluoroethylene elastic copolymer.

The curing with a polyamine is preferably conducted in a curing system in which a polyamine compound as a curing agent is used together with an acid receiving agent. As the polyamine compounds, there can be used, for example, hexamethylenediamine, hexamethylenediamine dicarbamate, dicinnamylidene hexamethylenediamine and others. As the acid receiving agents, there can be used, for example, oxides or hydroxides of divalent metals such as magnesium, calcium, zinc, lead and others. A use amount of a polyamine compound is preferably in the range of from 0.3 to 3 parts by mass relative to 100 parts by mass of a vinylidene fluoride/hexafluoropropylene/tetrafluoroethylene elastic copolymer and a use amount of an acid receiving agent is preferably in the range of from 1 to 30 parts by mass relative to 100 parts by mass of a vinylidene fluoride/hexafluoropropylene/tetrafluoroethylene elastic copolymer.

While curing of the vinylidene fluoride/hexafluoropropylene/tetrafluoroethylene elastic copolymer can also be conducted by methods of curing with the organic peroxide, curing with the polyol and curing with the polyamine, it is especially preferable, in the invention, to conduct curing of the elastic copolymer by irradiation with ionizing radiation. In a case of curing by irradiation with ionizing radiation, since no necessity arises for mixing a curing agent, a curing co-agent, an acid receiving agent and others thereinto, a sealing material less in quantity of a released gas is obtained to thereby make a speed faster at which a system of an semiconductor manufacturing device reaches a target vacuum state, which leads to an advantage that a throughput can be improved. Curing by irradiation with ionizing radiation requires molding prior to the irradiation, wherein though a problem is worried that a molded intermediate is generally deformed with ease and poor in shape retaining property, the molded intermediate of the invention has a fluorine content in a specific range, and therefore, is excellent in shape retaining property and hard to be deformed, thereby enabling a product less in dimensional error to obtained.

No specific limitation is not placed on an ionizing radiation and for example, preferable are an electron beam and γ-rays. An irradiation dose of a radiation is preferably in the range of from 10 to 500 kGy and more preferably in the range of from 30 to 200 kGy. If an irradiation dose thereof is less than 10 kGy, there arises a tendency of insufficient crosslinking, while on the other hand, if the irradiation dose exceeds 500 kGy, there arises a fear of degradation in an obtained sealing material.

In the first sealing material for semiconductor device, a fluororubber serving as a rubber component is indispensably required to be a cured product of the vinylidene fluoride/hexafluoropropylene/tetrafluoroethylene elastic copolymer, which is preferably contained in content of at least 50 parts by mass relative to 100 parts by mass of the fluororubber.

The fluororubber may be combined with mixing agents such as a curing agent, a curing co-agent and an acid receiving agent, all being describe above, in the ranges in which no effect of the invention is impaired; fillers such as carbon black, silica, clay, talc, glass fibers; pigments such as titanium oxide and red iron oxide; a fatty acid and derivatives of a fatty acid such as a fatty acid salt, a fatty acid ester; internal releasing agents such as paraffin wax and polyethylene wax; other resins; and rubbers.

Note that the first sealing material for semiconductor device can be obtained by molding with a conventionally known method such as compression molding or extrusion molding.

The first sealing material for semiconductor device has excellent plasma resistance even in a plasma environment of a mixed gas composed of oxygen gas and a fluorocarbon gas as well as in a plasma environment of oxygen gas or a fluorocarbon gas alone. Therefore, the first sealing material can be preferably used in any kind of semiconductor device regardless of a kind of gas. Since the first sealing material can be provided inexpensively, an advantage is enjoyed that the first sealing material is used in applications rich in general versatility and an application thereof is not specifically restricted to a particular scope thereof.

<Second Sealing Material for Semiconductor Device>

The second sealing material for semiconductor device of the invention is a product obtained by crosslinking a fluororubber preform with ionizing radiation, wherein the fluororubber preform contains a fluororubber component (a) comprising an elastic copolymer and a non-elastic fluororesin component (b). Thereby, the second sealing material for semiconductor device not only is excellent in plasma resistance, but also has a surface smoothness and a dimensional precision. Note that the term “elasticity” is a property that a larger deformation occurs by a smaller stress, and an deformed object tends to restore the almost original shape rapidly from the deformation and does not fluidized under pressure at a high temperature, and the term “an elastic copolymer” means to have a crosslinkable molecular structure in a molecule and to form a three-dimensional network structure by crosslinking and to thereby exhibit the elasticity. On the other hand, the term “non-elasticity” is a nature not to cause almost no deformation by a small stress, not to restore an object to the original shape after the object is deformed once and to fluidize the object under pressure at a high temperature, and non-elastic resin means a resin having no crosslinkable molecular structure in a molecule. A second sealing material for semiconductor device can be preferably obtained by means of a manufacturing method of the invention described later, to which the manufacturing method is not intended to be limited.

A fluororubber component (a) contained in a second sealing material for semiconductor device is a vinylidene fluoride/hexafluoropropylene elastic copolymer and/or a vinylidene fluoride/hexafluoropropylene/tetrafluoroethylene elastic copolymer.

A copolymerization ratio of respective monomers in the vinylidene fluoride/hexafluoropropylene elastic copolymer is preferably vinylidene fluoride/hexafluoropropylene=(50 to 95)/(5 to 50) (in mol %) and more preferably vinylidene fluoride/hexafluoropropylene=(70 to 85)/(15 to 30) (in mol %). A copolymerization ratio of respective monomers in the vinylidene fluoride/ hexafluoropropylene/tetrafluoroethylene elastic copolymer is preferably vinylidene fluoride/hexafluoropropylene/tetrafluoroethylene=(20 to 80)/(10 to 70)/(10 to 70)(in mol %) and more preferably vinylidene fluoride/hexafluoropropylene/tetrafluoroethylene=(25 to 70)/(15 to 60)/(15 to 60) (in mol %).

The vinylidene fluoride/hexafluoropropylene elastic copolymer and the vinylidene fluoride/hexafluoropropylene/tetrafluoroethylene elastic copolymer may be copolymerized with a monomer or monomers other than vinylidene fluoride, hexafluoropropylene and tetrafluoroethylene in ranges thereof in which no characteristic is impaired by the copolymerization of the monomer or monomers. Examples of the other monomers than vinylidene fluoride, hexafluoropropylene and tetrafluoroethylene include: fluorinated olefins such as chlorotrifluoroethylene, vinyl fluoride, pentafluoropropylene and others; perfluoro(alkyl vinyl ether)s such as perfluoro(methyl vinyl ether), perfluoro(propyl vinyl ether), perfluoro(3,6-dioxa-5-methyl-1-decene) and others; hydrocarbon olefins such as ethylene, propylene, butene and others; and alkyl vinyl ethers such as ethyl vinyl ether, butyl vinyl ether and others. The other monomers may be copolymerized with the elastic polymers alone or in two or more kinds. Note that in a case where a monomer or monomers from the other monomers is copolymerized, a total copolymerization ratio thereof is preferably in the range of from 0.1 to 30 mol % and more preferably in the range of from 0.2 to 15 mol % relative to the total of vinylidene fluoride, hexafluoropropylene and tetrafluoroethylene.

No specific limitation is imposed on a fluorine content in the fluororubber component (a) and a fluorine content thereof is preferably in the range of from 65 to 75 mass % and more preferably in the range of from 71 to 75 mass %. In a case where a fluorine content is in the range, a small weight-loss by exposure to a plasma is resulted because of excellency in plasma resistance. If a fluorine content is less than 65 mass %, there arises a possibility of insufficient plasma resistance, while on the other hand, if a fluorine content exceeds 75 mass %, there arises a tendency of losing rubber elasticity, leading to difficulty in fabrication.

Note that in a second sealing material for semiconductor device as well, a fluorine content can be measured in a procedure in which a fluororubber component (b) is burned to free fluorine as fluorine ions and to trap the fluorine ions, followed by quantification of a fluorine ion concentration with an ion concentration meter and the measurement has only to follow a method described in NIPPON KAGAKU KAISHI, 1973, p 1236 to 1237, for example.

A fluororubber component (a) may have a bromine atom, an iodine atom or a double bond as a crosslinking site in a molecule. A bromine atom, an iodine atom or a double bond, in a case where a fluororubber is manufactured through polymerization of monomers, can be introduced into the fluororubber by adding small quantities of a chain transfer agent or a crosslinking site monomer having a bromine atom, an iodine atom or a double bond, or alternatively, by applying an after-treatment such as a heat treatment or an alkaline treatment to an obtained fluorine rubber. Examples of the chain transfer agents specifically include: perfluoro(1,4-diiodobutane), perfluoro( 1-bromo-4-iodobutane), perfluoro( 1,6-diiodohexane), perfluoro(1,8-diiodooctane). Examples of the crosslinking site monomers, to be concrete, include: perfluoro(3-iodo-1-propene), perfluoro(4-iodo-1-butene), perfluoro(4-bromo-1-butene), perfluoro(5-bromo-8-oxa-1-pentene), perfluoro(6-iodo-1-hexene) and others.

No specific limitation is placed on a manufacturing method to obtain the fluororubber component (a) and there can be adopted known methods such as bulk polymerization, suspension polymerization, emulsion polymerization, solution polymerization and others, among which preferable are emulsion polymerization and suspension polymerization. Examples of the polymerization initiating reactions include: a radical polymerization method using an organic peroxide initiator, an azo initiator or the like; a redox polymerization method using a redox catalyst; a radiation polymerization method using ionizing radiation; a polymerization method using heat or light and others, among which preferable are a radical polymerization method and a redox polymerization method.

No specific limitation is placed on a molecular weight of a fluororubber component (a) and a molecular weight thereof is preferably in the range of from 2,000 to 500,000 from the viewpoint from a physical property and moldability.

No specific limitation is imposed on a glass transition temperature of a fluororubber component (a) and a glass transition temperature thereof is preferably 10° C. or lower. If a glass transition temperature thereof exceeds 10° C., a tendency arises that flexibility at a low temperature is poorer and sealability decreases.

A fluororesin component (b) in a second sealing material for semiconductor device is a non-elastic vinylidene fluoride (co)polymer.

As concrete Examples of the non-elastic vinylidene fluoride (co)polymers, there are named polyvinylidene fluoride, and a copolymer of vinylidene fluoride and a monomer copolymerizable therewith. Preferable Examples of the monomers copolymerizable with vinylidene fluoride, to be concrete, include: hexafluoropropylene and tetrafluoroethylene, and in addition thereto, fluorinated olefins such as chlorotrifluoroethylene, vinyl fluoride, pentafluoropropylene and others; perfluoro(alkyl vinyl ether)s such as perfluoro(methyl vinyl ether), perfluoro(propyl vinyl ether), perfluoro(3,6-dioxa-5-methyl-1-decene) and others; hydrocarbon olefins such as ethylene, propylene, butene and others; and alkyl vinyl ethers such as ethyl vinyl ether, butyl vinyl ether and others. The monomers copolymerizable with vinylidene fluoride may be used alone or in two or more kinds. The vinylidene fluoride (co)polymer may be a thermoplastic rubber having a vinylidene fluoride (co)polymer component as a hard segment.

In a case where a vinylidene fluoride (co)polymer is a copolymer, a copolymerization ratio of vinylidene fluoride is preferably 25 mol % or more.

No specific limitation is placed on a manufacturing method to obtain a fluororesin component (b) and there can be adopted known methods such as bulk polymerization, suspension polymerization, emulsion polymerization, solution polymerization and others, among which preferable are emulsion polymerization and suspension polymerization. Examples of the polymerization initiating reactions include: a radical polymerization method using an organic peroxide initiator, an azo initiator or the like; a redox polymerization method using a redox catalyst; a radiation polymerization method using ionizing radiation; a polymerization method using heat or light and others, among which preferable are a radical polymerization method and a redox polymerization method.

No specific limitation is placed on a melting point of a fluororesin component (b) and a melting point thereof is preferably in the range of 100 to 200° C. A melting heat thereof is preferably in the range of from 3 to 30 J/g in DSC measurement.

No specific limitation is placed on a weight average molecular weight of a fluororesin component (b) and a weight average molecular weight thereof is preferably in the range of from 2,000 to 500,000 and more preferably in the range of 20,000 to 300,000.

In a second sealing material for semiconductor device, it is important that a ratio of a fluororubber component (a) and a fluororesin component (b) in a fluororubber preform is such that the fluororesin component (b) is contained in the range of 1 to 50 parts by mass relative to 100 parts by mass of the fluororubber component (a). The ratio is preferably such that the fluororesin component (b) is contained in the range of 5 to 20 parts by mass relative to 100 parts by mass of the fluororubber component (a). If a ratio of a fluororesin component (b) is less than the range, a dimensional precision and a surface smoothness of a sealing material are impaired, while on the other hand, if a ratio of a fluororesin component (b) is more than the range, rubber elasticity of the sealing material is insufficient.

A fluororubber preform may be contained additives, in the ranges in which no effect of the invention is impaired, including fillers such as carbon black, silica, clay, talc, glass fibers; pigments such as titanium oxide and red iron oxide; a fatty acid and derivatives of a fatty acid such as a fatty acid salt and a fatty acid ester; internal releasing agents such as paraffin wax and polyethylene wax; and resins and rubbers other than a fluororubber component (a) and a fluororesin component (b). Note that in a case where a fluororubber preform includes a component or components other than a fluororubber component (a) and a fluororesin component (b), it is preferable to contain a fluororubber component (a) and a fluororesin component (b) in a total content of 50 mass % or more relative to the mass of a fluororubber preform.

A manufacturing method for a second sealing material for semiconductor device is such that a fluororubber component (a), a fluororesin component (b) and a component or components other than the components (a) and (b) when required are mixed together in the ratios, thereafter, the mixture is preformed and the obtained preform is irradiated with ionizing radiation.

It is important that mixing of a fluororubber component (a) and a fluororesin component (b) is conducted at a temperature of the melting point of the fluororesin component (b) or higher. By mixing a fluororubber component (a) and a fluororesin component (b) at a temperature of the melting point of the fluororesin component (b) or higher, the fluororubber component (a) and the fluororesin component (b) are dissolved into each other in good dispersion, thereby enabling a property of the fluororesin component (b) to be imparted to the fluororubber component (a) with uniformity. Since with such an operation applied, a preform prior to irradiation with ionizing radiation is improved with respect to shape retaining property, excellent in dimensional stability and surface smoothness; therefore no carefulness is necessary in handling of the preform prior to irradiation with ionizing radiation, which enables the preform to be subjected to irradiation with ionizing radiation with good operability, with the result that a sealing material can be obtained with excellency in dimensional precision. No necessity arises for a crosslinking agent, a filler or the like, which are used for imparting the preform moldability, whereby a high purity sealing material that is excellent in plasma resistance and less in generation of particles and less in weight-loss of a sealing material during exposure to a plasma can be obtained.

No specific limitation is placed on a means adopted in mixing a fluororubber component (a) and a fluororesin component (b) and it is preferable to use mixing devices such as a roll mill, a kneader, an extruder and others.

In preforming, it is preferable to use an extrusion molding machine, a heat press molding machine and others. Note that no specific limitation is placed on a concrete method or conditions for the preforming, which has only to be set in a proper manner.

No specific limitation is placed on ionizing radiation that can be used during irradiation of a fluororubber preform with ionizing radiation and preferable are an electron beam and γ rays. An irradiation dose of radiation is preferably in the range of from 10 to 500 kGy and more preferably in the range of from 30 to 200 kGy. If an irradiation dose thereof is less than 10 kGy, there arises a tendency that crosslinking is insufficient, while on the other hand, if an irradiation dose thereof is more than 500 kGy, there arises a possibility of degradation of an obtained sealing material.

### DETAILED DESCRIPTION OF THE PREFERRED EMBODIMENTS

While more detailed description will be given of the invention below using examples and comparative examples, it should be noted that the invention is not limited in any way by the description.

Firstly, description is given of examples and comparative examples of a first sealing material for semiconductor device concerning the invention and subsequent to this, description is given of examples and comparative examples of a second sealing material for semiconductor device concerning the invention.

[First Sealing Material for Semiconductor Device]

Evaluation of sealing materials obtained in the examples and comparative examples described below was conducted in ways described below.

<Plasma Resistance>

Plasma resistances of a first sealing material to three kinds of gases of O₂/CF₄ (with a flow rate ratio O₂/CF₄=9/1 (in volume ratio)), O₂ gas and CF₄ gas were evaluated by measuring weights (masses) of specimens before and after a plasma exposure test conducted in a procedure in which a parallel plate low temperature plasma exposure device (with electrodes of 300 mm in diameter spaced apart from each other by a spacing of 50 mm) was employed, sealing material in the shape of a sheet was placed on the electrode on the earth side and the specimen was exposed to a plasma under conditions of an RF output of 500 W, a plasma exposure time of 3 hr, a total gas flow rate of 150 sccm and a vacuum degree of 80 Pa and calculating a weight-loss ratio by the following formula, wherein a mass before test is x (g) and a mass after test is y (g). It can be said that the less a weight-loss ratio is, the sealing material is more excellent in plasma resistance.
Weight-loss ratio (%)=[(x−y)/x]×100
<Compression Set>

A sealing material in the shape of an O-ring was compressed so that a compressibility is 25% according to JIS K 6262 with compressing plates between which a spacer was inserted at 230° C. for 24 hr to thereby measure a compression set (%).

### EXAMPLE 1-1

Put into a 1 L stainless autoclave were 600 g of deoxidized water, 0.2 g of ammonium perfluorooctanoate, 2.1 g of disodium hydrogen phophate·12 hydrate, 0.6 g of ammonium persulfate and 0.4 g of 1,4-diiodoperfluorobutane, then, further put into the mixture was 65 g of a mixed monomer (A) of vinylidene fluoride, hexafluoropropylene and tetrafluoroethylene in mole ratio of 8 to 82 to 10, followed by increase a pressure in the autoclave to 1.5 MPa·G. Subsequent to this, a temperature in the autoclave was in the range of 70 to 73° C. to thereby conduct polymerization. Since in the course of progress in polymerization, the mixed monomer in the autoclave was consumed to thereby decrease a pressure therein, a mixed monomer (B) of vinylidene fluoride, hexafluoropropylene and tetrafluoroethylene in mole ratio of 36 to 26 to 38 was continued to be intermittently supplemented so that a pressure in the autoclave was in the range of from 1.45 to 1.5 MPa·G. When 330 g of the mixed monomer (B) was put in, polymerization is ceased and a gas phase in the autoclave was purged to as low as the atmospheric pressure to thereby obtain a latex of fluororubber. The latex was coagulated in a 10% sodium chloride aqueous solution and thereafter, the coagulation was washed with ion-exchange water and dried at 120° C. for 24 hr to thereby obtain 321 g of a fluororubber. The obtained fluororubber has a copolymerization ratio of vinylidene fluoride, hexafluoropropylene and tetrafluoroethylene of 36 to 26 to 38 (in mol %), a fluorine content is 72.2 mass % and a content of iodine atoms was 0.18 mass %.

Then, the obtained fluororubber is press-molded at 30° C. to prepare a sheet with a size of 35 mm×5 mm×2 mm and an O-ring (with an inner diameter thereof of 24.99 mm and a circular cord of 3.53 mm in cord diameter). Then, the sheet and the O-ring is irradiated with y rays at a dose of 80 kGy and thereby cured to obtain sealing materials in the shapes of a sheet and an O-ring. A result of the evaluation on the obtained sealing materials is shown in Table 1.

### EXAMPLE 1-2

A fluororubber was obtained in a quantity of 312 g in a similar way to that in Example 1-1 with the exception that 1,4-diiodoperfluorobutane was not used, the composition of a mixed monomer (A) initially put into the autoclave is such that a mole ratio of vinylidene fluoride, hexafluoropropylene and tetrafluoroethylene is 5 to 81 to 14 and the composition of a mixed monomer (B) intermittently put into the autoclave in the course of progress in polymerization is such that a mole ratio of vinylidene fluoride, hexafluoropropylene and tetrafluoroethylene is 29 to 27 to 44. The obtained fluororubber has a copolymerization ratio of vinylidene fluoride, hexafluoropropylene and tetrafluoroethylene of 29 to 28 to 43 (in mol %) and a fluorine content is 73.0 mass %.

Then, the obtained fluororubber is molded and thereafter cured in a similar way to that in Example 1-1 to obtain sealing materials in the shapes of a sheet and an O-ring. A result of the evaluation on the obtained sealing materials is shown in Table 1.

### EXAMPLE 1-3

Uniformly mixed together with a two-roll mill were 100 parts by mass of the fluororubber obtained in Example 1- 1, 4 parts by mass of triallyl isocyanurate, 1 part of mass of an organic peroxide (with a trade name of PERHEXA 2.5B, manufactured by NOF CORPORATION). Subsequent to this, the mixture was press cured at 170° C. for 15 min to form the mixture into the shapes of a sheet (with a size of 35 mm×5 mm×2 mm) and an O-ring (with an inner diameter of 24.99 mm and a circular cord of 3.53 mm in cord diameter) to thereby, obtain sealing materials in the shapes of a sheet and an O-ring. A result of the evaluation on the obtained sealing materials is shown in Table 1.

### COMPARATIVE EXAMPLE 1-1

A fluororubber was obtained in a quantity of 325 g in a similar way to that in Example 1-1 with the exception that 1,4-diiodoperfluorobutane was not used, the composition of a mixed monomer (A) initially put into the autoclave is such that a mole ratio of vinylidene fluoride, hexafluoropropylene and tetrafluoroethylene is 17 to 62 to 21 and the composition of a mixed monomer (B) intermittently put into the autoclave in the course of progress in polymerization is such that a mole ratio of vinylidene fluoride, hexafluoropropylene and tetrafluoroethylene is 43 to 22 to 35. The obtained fluororubber has a copolymerization ratio of vinylidene fluoride, hexafluoropropylene and tetrafluoroethylene of 44 to 22 to 34 (in mol %) and a fluorine content is 71.1 mass %.

Then, the obtained fluororubber is molded and thereafter cured in a similar way to that in Example 1-1 to obtain sealing materials in the shapes of a sheet and an O-ring. A result of the evaluation on the obtained sealing materials is shown in Table 1.

### COMPARATIVE EXAMPLE 1-2

A fluororubber was obtained in a quantity of 316 g in a similar way to that in Example 1-1 with the exception that 1,4-diiodoperfluorobutane was not used, the composition of a mixed monomer (A) initially put into the autoclave is such that a mole ratio of vinylidene fluoride, hexafluoropropylene and tetrafluoroethylene is 22 to 65 to 13 and the composition of a mixed monomer (B) intermittently put into the autoclave in the course of progress in polymerization is such that a mole ratio of vinylidene fluoride, hexafluoropropylene and tetrafluoroethylene is 50 to 25 to 25. The obtained fluororubber has a copolymerization ratio of vinylidene fluoride, hexafluoropropylene and tetrafluoroethylene of 50 to 25 to 25 (in mol %) and a fluorine content is 70.4 mass %.

Then, the obtained fluororubber is molded and thereafter cured in a similar way to that in Example 1-1 to obtain sealing materials in the shapes of a sheet and an O-ring. A result of the evaluation on the obtained sealing materials is shown in Table 1.

### COMPARATIVE EXMAPLE 1-3

Uniformly mixed together with a two-roll mill were 100 parts by mass of a vinylidene fluoride/hexafluoropropylene/tetrafluoroethylene copolymer (with a trade name of DAI-EL G801, manufactured by DAIKIN INDUSTRIES, LTD. of a fluorine content of 66 mass %), 4 parts by mass of trially isocyanurate, and 1 part by mass of an organic peroxide (with a trade name of PERHEXA 2,5B, manufactured by NOF CORPORATION). Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in diameter) and thereafter, the molded intermediates were subjected to secondary curing at 180° C. for 24 hr to thereby obtain sealing materials in the shapes of a sheet and an O-ring. A result of the evaluation on the obtained sealing materials is shown in Table 1.

### COMPARATIVE EXMAPLE 1-4

Uniformly mixed together with a two-roll mill were 100 parts by mass of a vinylidene fluoride/hexafluoropropylene/tetrafluoroethylene copolymer (with a trade name of DAI-EL G921, manufactured by DAIKIN INDUSTRIES, LTD. of a fluorine content of 71 mass %), 4 parts by mass of trially isocyanurate, and 1 part by mass of an organic peroxide (with a trade name of PERHEXA 2,5B, manufactured by NOF CORPORATION). Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in cord diameter) and thereafter, the molded intermediates were subjected to secondary curing at 180° C. for 4 hr to thereby obtain sheet sealing materials in the shapes of a sheet and an O-ring. A result of the evaluation on the obtained sealing materials is shown in Table 1.

### COMPARATIVE EXAMPLE 1-5

Uniformly mixed together with a two-roll mill were 100 parts by mass of an ethylene/perfluorovinyl ether/tetrafluoroethylene copolymer (with a trade name of Viton ETP900, manufactured by DU PONT KABUSHIKI KAISHA of a fluorine content of 67 mass %), 4 parts by mass of trially isocyanurate, 3 parts by mass of calcium hydroxide and 1 part by mass of an organic peroxide (with a trade name of PERHEXA 2,5B, manufactured by NOF CORPORATION). Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in cord diameter) and thereafter, the molded intermediates were subjected to secondary curing at 230° C. for 4 hr to thereby obtain sealing materials in the shapes of a sheet and an O-ring. A result of the evaluation on the obtained sealing materials is shown in Table 1.

### COMPARATIVE EXAMPLE 1-6

Uniformly mixed together with a two-roll mill were 100 parts by mass of a vinylidene fluoride/perfluorovinyl ether/tetrafluoroethylene copolymer (with a trade name of DAI-EL LT302, manufactured by DAIKIN INDUSTRIES, LTD., of a fluorine content of 62 mass %), 4 parts by mass of trially isocyanurate and 1 part by mass of an organic peroxide (with a trade name of PERHEXA 2,5B, manufactured by NOF CORPORATION). Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in cord diameter) and thereafter, the molded intermediates were subjected to secondary curing at 180° C. for 4 hr to thereby obtain sealing materials in the shapes of a sheet and an O-ring. A result of the evaluation on the obtained sealing materials is shown in Table 1.

### COMPARATIVE EXAMPLE 1-7

Uniformly mixed together with a two-roll mill were 100 parts by mass of a vinylidene fluoride/perfluorovinyl ether/tetrafluoroethylene copolymer (with a trade name of DAI-EL LT302, manufactured by DAIKIN INDUSTRIES, LTD., of a fluorine content of 62 mass %), 10 parts by mass of polyethylene resin powder (with a trade name of MIPELON XM220U, manufactured by MITSUI CHEMICALS, INC.), 4 parts by mass of trially isocyanurate and 1 part by mass of an organic peroxide (with a trade name of PERHEXA 2,5B, manufactured by NOF CORPORATION). Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in cord diameter) and thereafter, the molded intermediates were subjected to secondary curing at 180° C. for 4 hr to thereby obtain sealing materials in the shapes of a sheet and an O-ring. A result of the evaluation on the obtained sealing materials is shown in Table 1.

### COMPARATIVE EXAMPLE 1-8

Uniformly mixed together with a roll mill were 100 parts by mass of a vinylidene fluoride/perfluorovinyl ether/tetrafluoroethylene copolymer (with a trade name of DAI-EL G501, manufactured by DAIKIN INDUSTRIES, LTD., of a fluorine content of 68 mass %), 3 parts by mass of polyamine crosslinking agent (with a trade name of V-3, manufactured by DAIKIN INDUSTRIES, LTD.) and 10 parts by mass of magnesium oxide. Then, the mixture was press cured at 170° C. for 15 min and formed into the shapes of a sheet (with a size of 35 mm×5 mm×2 mm) and an O-ring (with an inner diameter of 24.99 mm and a circular cord of 3.53 mm in cord diameter) and thereafter, the molded intermediates were subjected to secondary curing at 230° C. for 24 hr to thereby obtain sealing materials in the shapes of a sheet and an O-ring. A result of the evaluation on the obtained sealing materials is shown in Table 1.

TABLE 1

| | | | Plasma resistance | | | |
|---|---|---|---|---|---|---|
| | | Fluorine | <weight-loss ratio> (%) | | | Com- |
| | | content | O₂ + CF₄ | O₂ | CF₄ | pression |
| | | (wt %) | gas | gas | gas | set (%) |
| Examples | 1-1 | 72.2 | 3.5 | 1.4 | 0.8 | 33 |
| | 1-2 | 73.0 | 2.4 | 1.1 | 0.7 | 35 |
| | 1-3 | 72.2 | 3.4 | 1.3 | 0.8 | 31 |
| Comparative | 1-1 | 71.1 | 7.5 | 5.2 | 3.0 | 32 |
| Examples | 1-2 | 70.4 | 8.5 | 5.7 | 3.4 | 30 |
| | 1-3 | 66.0 | 14.2 | 8.8 | 5.1 | 25 |
| | 1-4 | 71.0 | 8.0 | 5.3 | 3.2 | 31 |
| | 1-5 | 67.0 | 12.6 | 7.2 | 4.7 | 35 |
| | 1-6 | 62.0 | 16.3 | 11.2 | 6.3 | 32 |
| | 1-7 | 62.0 | 14.5 | 9.3 | 5.7 | 35 |
| | 1-8 | 68.0 | 10.3 | 6.5 | 4.8 | 34 |

It was found from the results of Table 1 that the sealing materials of the comparative examples have fluorine contents in the range of from 62.0 to 71.1 mass %; therefore, a weight-loss ratio is large.

A weight-loss ratio especially in a plasma environment of a mixed gas of O₂/CF₄, which is the severest condition, is as large as in the range of 7.5 to 16.3% and it is inferred that a change in shape occurs in such a plasma environment, which makes it difficult to keep a performance as a sealing material. Contrast thereto, the sealing materials of the invention are all low in weight-loss ratio in plasma environments of all the gas or mixed gas and a weight-loss ratio in a plasma environment of the mixed gas of O₂/CF₄ is extremely lower than that in the comparative examples by a factor of about ½ to ¼, from which it is apparent that the sealing materials of the invention is excellent in plasma resistance to various gases. It can be said that the sealing materials of the invention are also good in compression set and have a sealing performance in practical use. Therefore, the sealing materials of the invention are, in a case where being used in a semiconductor device, guessed to have a lifetime longer as compared with a conventional sealing material.

### REFERENCE EXAMPLE

In order to evaluate a quantity of a released gas according to a different curing method, a quantity of a released gas after leaving a specimen as it is for 50 hr at room temperature was measured on each of the sealing materials obtained in Examples 1-1, 1-3 and Comparative Examples 1-4, 1-7 and 1-8 was measured according to a throughput method using a released gas rate measuring instrument (with a model No. BB1683, manufactured by ULVAC, Inc.). Note that a quantity of a released gas was calculated by the following formula:
Q=C(P1−P2)/A
wherein Q indicates a quantity of a released gas (Pa.m³/s.m²), C indicates a conductance of an orifice (m³/s), P1 indicates a pressure in a measurement chamber 1 (Pa), P2 indicates a pressure in a measurement chamber 2 (Pa) and A indicates a surface area (m²) of a specimen.

As a result of the measurement, quantities of released gases were as follows:

From the sealing material of Example 1-1, it is 7.3×10⁻⁶ (Pa.m³/s.m²),

from the sealing material of Example 1-3, it is 4.8×10⁻⁵ (Pa.m³/s.m²),

from the sealing material of Comparative Example 1-4, it is 5.3×10⁻⁵ (Pa.m³/s.m²),

from the sealing material of Comparative Example 1-7, it is 4.9×10⁻⁵ (Pa.m³/s.m²), and

from the sealing material of Comparative Example 1-8, it is 1.2×10⁻⁴ (Pa.m³/s.m²).

It is apparent from the results that quantities of released gases from the sealing material of Comparative Example 1-8 by amine curing are the largest and quantities of released gases of the sealing materials of Examples 1-3, Comparative Examples 1-4 and Comparative Examples 1-7 each by peroxide curing are almost the same and the second largest, whereas the sealing material of Example 1-1 cured by irradiation with ionizing radiation is extremely smaller in quantity of a released gas.

[Second Sealing Material for Semiconductor Device]

Evaluation of sealing materials obtained in the examples and comparative examples described below was conducted in ways described below.

<Dimensional Precision (Circularity of O-Ring)>

A cord diameter and a height were measured at 4 sites with an equal spacing between adjacent sites on the circumference of the O-ring, which was a sealing material, using a dimension measuring microscope, a circularity was calculated by the following formula from obtained values at each measurement site and the average of the circularities at the 4 sites was adopted as a circularity of the O-ring. The closer to 1 the value is, the shape is closer to a true circle, which can be said as being excellent in dimensional precision. Note that circularities at measurement sites are shown in < >s in Table 2:
Circularity=Cord Diameter/Height

Note that since according to an O-ring dimensional standard stipulated in JIS B 2401, an allowable dimensional deviation of an O-ring with a cord diameter of 5.7 mm is within ±0.13 mm thereof, the maximum value of a cord diameter is 5.83 mm and the minimum value thereof is 5.57 mm in the extreme cases, in which situation a circularity is 1.047. Therefore, with a circularity of 1.047 or more, an O-ring is a product inappropriate in practical use.

<Plasma Resistance>

A parallel plate low temperature plasma exposure device (with electrodes of 300 mm in diameter spaced apart from each other with a spacing of 50 mm) was employed. A weight (masses) of the sealing material before and after a plasma exposure test was measured in which a sealing material in the shape of was placed on the electrode on the earth side and the specimen was exposed to a plasma under conditions of an RF output of 500 W, a plasma exposure time of 3 hr, a gas mixing ratio of O₂/CF₄=9/1 (in flow rate or volume ratio), a total gas flow rate of 150 sccm and a vacuum degree of 80 Pa and a weight-loss ratio was calculated by the following formula, wherein a mass before test is x (g) and a mass after test is y (g). It can be said that the less a weight-loss ratio is, the sealing material is more excellent in plasma resistance.
Weight-loss ratio (%)=[(x−y)/x]×100

### EXAMPLE 2-1

Uniformly mixed together at 240° C. with an extrusion machine were 100 parts by mass of a vinylidene fluoride/hexafluoropropylene/tetrafluoroethylene elastic copolymer as a fluororubber component (a) (with a mole ratio of vinylidene fluoride, hexafluoropropylene and tetrafluoroethylene=35 to 25 to 40 and a molecular weight of 150,000), 10 parts by mass of a polyvinylidene fluoride (with a melting point of 172° C. and a melting heat of 15.5 J/g as measured with DSC) as a fluororesin component (b) and thereafter, the obtained mixture was extruded through an opening of 5 mm in diameter at 240° C. to thereby preform the mixture into a cord. Then, the obtained preform in the shape of a cord was cut into segments each of 26.7 cm in length and both ends of each segment are welded by heating them at 250° C. to obtain an O-ring preform with an inner diameter of 80 mm. A thickness (diameter) of a cord was measured at 4 sites with an equal spacing between adjacent sites on the circumference of the O-ring using a dimension measuring microscope, as a result, a difference between the maximum value and the minimum value (a dispersion of a thickness) was 0.07 mm and a surface of the obtained O-ring preform was visually observed smooth. Note that thicknesses of measurement sites are shown in < >s in Table 2.

Then, the obtained O-ring preform was left as it was at room temperature (about 23° C.) for 8 hr and thereafter, the preform was irradiated with γ rays at a dose of 50 kGy and crosslinked to thereby obtain a sealing material in the shape of an O-ring. In Table 2, there are shown the results of the evaluation on dimensional precision and plasma resistance of the obtained sealing material in the shape of an O-ring.

### EXAMPLE 2-2

Uniformly mixed together at 200° C. with an extrusion machine were 100 parts by mass of the fluororubber component (a) used in Example 2-1, 15 parts by mass of a vinylidene fluoride/hexafluoropropylene copolymer as a fluororesin component (b) (with a mole ratio of vinylidene fluoride and hexafluoropropylene=93 to 7, a melting point of 145° C. and a melting heat of 13.9 J/g as measured with DSC) and thereafter, the obtained mixture was extruded through an opening of 5 mm in diameter at 200° C. to thereby preform the mixture into a cord. Then, the obtained preform in the shape of a cord was cut into segments each of 26.7 cm in length and both ends of each segment are welded by heating them at 200° C. to obtain an O-ring preform with an inner diameter of 80 mm. A thickness (diameter) of a cord of the obtained O-ring preform was measured at 4 sites with an equal spacing between adjacent sites on the circumference of the O-ring preform using a dimension measuring microscope, as a result, a difference between the maximum value and the minimum value (a dispersion of a thickness) was 0.06 mm and a surface of the obtained O-ring preform was visually observed smooth. Note that thicknesses of measurement sites are shown in < >s in Table 2.

Then, the obtained O-ring preform was left as it was at room temperature (about 23° C.) for 8 hr and thereafter, the preform was irradiated with γ rays at a dose of 50 kGy and crosslinked to thereby obtain a sealing material in the shape of an O-ring. In Table 2, there are shown results of the evaluation on a dimensional precision and plasma resistance of the obtained sealing material in the shape of an O-ring.

### COMPARATIVE EXAMPLE 2-1

Only 100 parts by mass of the fluororubber component (a) used in Example 2-1 was extruded through an opening of 5 mm in diameter at 200° C. using an extrusion machine to thereby preform the mixture into a cord. Then, the obtained preform in the shape of a cord was cut into segments each of 26.7 cm in length and both ends of each segment are welded by heating them at 100° C. to obtain an O-ring preform with an inner diameter of 80 mm. A thickness (diameter) of a cord of the obtained O-ring preform was measured at 4 sites with an equal spacing between adjacent sites on the circumference of the O-ring preform using a dimension measuring microscope, as a result, a difference between the maximum value and the minimum value (a dispersion of a thickness) was 0.55 mm and a surface of the obtained O-ring preform was visually observed unsmooth. Note that thicknesses of measurement sites are shown in < >s in Table 2.

Then, the obtained O-ring preform was left as it was at room temperature (about 23° C.) for 8 hr and thereafter, the preform was irradiated with γ rays at a dose of 50 kGy and crosslinked to thereby obtain a sealing material in the shape of an O-ring. In Table 2, there are shown the results of the evaluation on a dimensional precision and plasma resistance of the obtained sealing material in the shape of an O-ring.

TABLE 2

| | Example | Example | Comparative |
|---|---|---|---|
| | 2-1 | 2-2 | Example 2-1 |
| Thickness dispersion of | 0.07 | 0.06 | 0.55 |
| O-ring preform (mm) | <5.04> | <4.97> | <5.32> |
| <cord diameter at each of | <5.06> | <5.00> | <4.77> |
| measurement sites (mm)> | <5.03> | <5.03> | <5.11> |
| | <4.99> | <4.99> | <4.84> |
| Dimensional precision | 1.0045 | 1.0025 | 1.1025 |
| (circularity) | <1.014> | <1.008> | <1.115> |
| <circularity at each of | <1.002> | <0.988> | <1.099> |
| measurement sites> | <1.008> | <1.012> | <1.083> |
| | <0.994> | <1.002> | <1.113> |
| Plasma resistance | 4.2 | 4.0 | 3.8 |
| (weight-loss ratio (%)) | | | |

It is found from the results described above that the O-ring preforms obtained in Examples 2-1 and 2-2 prior to irradiation with ionizing radiation are less in dispersion of a dimension and sufficient in surface smoothness, while the O-ring preform obtained in Comparative Example 2-1 prior to irradiation with ionizing radiation is more in dispersion of a dimension and insufficient in surface smoothness. The sealing materials obtained in Examples 2-1 and 2-2 have plasma resistance on the same level as the sealing material obtained in Comparative Example 2-1 and at the same time, have a circularity extremely close to 1, while the sealing material obtained in Comparative Example 2-1 exceeds 1.047 in circularity by a great margin, which lacks practicality as an O-ring substantially.

### INDUSTRIAL APPLICATION

According to the invention, there can be provided an inexpensive sealing material for semiconductor device having plasma resistance excellent in various kinds of plasma environments.

According to the invention, there can be easily obtained, with good workability, a sealing material for semiconductor device not only excellent in plasma resistance, but also provided with good surface smoothness and a dimension precision.

1. A sealing material for a semiconductor device, which is a sealing material comprising a fluororubber as a rubber component, wherein: the fluororubber inevitably comprises a cured product of a vinylidene fluoride/hexafluoropropylene/tetrafluoroethylene elastic copolymer; and copolymerization ratios of respective monomers in the vinylidene fluoride/hexafluoropropylene/tetrafluoroethylene elastic copolymer are such that: a content of vinylidene fluoride is in the range of from 25 to 70 mol %; a content of hexafluoropropylene is in the range of from 15 to 60 mol %; a content of tetrafluoroethylene is in the range of from 15 to 60 mol %; and a fluorine content in the vinylidene fluoride/hexafluoropropylene/tetrafluoroethylene elastic copolymer is in the range of from 71.5 to 75 mass %.

2. The sealing material for a semiconductor device according to claim 1, wherein curing of the vinylidene fluoride/hexafluoropropylene/tetrafluoroethylene elastic copolymer is performed by irradiation with ionizing radiation.

3. The sealing material for a semiconductor device according to claim 1 or 2, wherein a fluorine content of the vinylidene fluoride/hexafluoropropylene/tetrafluoroethylene elastic copolymer is in the range of from 72 to 74.5 mass %.

4. The sealing material for a semiconductor device according to claim 2, wherein an irradiation dose of the ionizing radiation is in the range of from 10 to 500 kGy.

5. A sealing material for a semiconductor device, which is obtained by crosslinking, with ionizing radiation, a fluororubber preform comprising:
i) a fluororubber component (a) comprising a vinylidene fluoride/hexafluoropropylene elastic copolymer and/or a vinylidene fluoride/hexafluoropropylene/tetrafluoroethylene elastic copolymer; and
ii) a non-elastic fluororesin component (b) comprising a vinylidene fluoride (co)polymer in composition of the fluororesin component (b) of 1 to 50 parts by mass relative to 100 parts by mass of the fluororubber component (a).

6. The sealing material for a semiconductor device according to claim 5, wherein a copolymerization ratio of respective monomers in the vinylidene fluoride/hexafluoropropylene elastic copolymer is vinylidene fluoride/hexafluoropropylene=(50 to 95)/(5 to 50)(in mol %).

7. The sealing material for a semiconductor device according to claim 5 or 6, wherein a copolymerization ratio of respective monomers in the vinylidene fluoride/hexafluoropropylene/tetrafluoroethylene elastic copolymer is vinylidene fluoride/hexafluoropropylene/tetrafluoroethylene=(20 to 80)/(10 to 70)/(10 to 70)(in mol %).

8. The sealing material for a semiconductor device according to claim 5 or 6, wherein a fluorine content of the fluororubber component (a) is in the range of from 65 to 75 mass %.

9. The sealing material for a semiconductor device according to claim 5 or 6, wherein a ratio of the fluororubber component (a) and the fluororesin component (b) is 5 to 20 parts by mass of the fluororesin component (b) relative to 100 parts by mass of the fluororubber component (a).

10. The sealing material for a semiconductor device according to claim 5 or 6, wherein an irradiation dose of the ionizing radiation is in the range of from 10 to 500 kGy.

11. A manufacturing method for a sealing material for a semiconductor device, comprising the steps of:
i) mixing a fluororubber component (a) with a non-elastic fluororesin component (b) to obtain a mixture, wherein the fluororubber component (a) comprises a vinylidene fluoride/hexafluoropropylene elastic copolymer and/or a vinylidene fluoride/hexafluoropropylene/tetrafluoroethylene elastic copolymer, wherein the non-elastic fluororesin component (b) comprises a vinylidene fluoride (co)polymer, wherein 100 parts by mass of the fluororubber component (a) is mixed with 1 to 50 parts by mass of the non-elastic fluororesin component (b) at a temperature of a melting point of the fluororesin component (b) or higher;
ii) preforming the mixture to obtain a preform; and
iii) irradiating the preform with ionizing radiation.
